(19) United States
(12) Patent Application Publication
(10) Pub. No.: US 2014/0267919 A1
(43) Pub. Date: Sep. 18, 2014

(54) MODIFYING A DIGITAL VIDEO SIGNAL TO MASK BIOLOGICAL INFORMATION

(71) Applicant: QUANTA COMPUTER, INC., Tao Yuan Shien (TW)

(72) Inventors: Steven Keith HELLER, Acton, MA (US); Eugene Inghaw SHIH, Brookline, MA (US)

(73) Assignee: QUANTA COMPUTER, INC., Tao Yuan Shien (TW)

(21) Appl. No.: 13/832,007

(22) Filed: Mar. 15, 2013

(51) Int. Cl. H04N 1/38

(52) U.S. Cl. CPC H04N 1/38
USPC 348/607

(57) ABSTRACT

Techniques are disclosed to process certain information contained in a digital video signal. In particular, a time-varying signal present in the digit video signal may be supplanted with a replacement time-varying signal, negated, or obfuscated with a noise signal. Negation of the time-varying signal may include extracting said time-varying signal from the digital video signal, inverting the time-varying signal, and adding the inverted time-varying signal to the original digital video signal. Obfuscation of the time-varying signal may be accomplished by introducing a suitable noise signal to the original digital video signal. Supplanting the time-varying signal with a replacement signal may include negating the time-varying signal and introducing a desired replacement signal to the digital video signal.

### BACKGROUND

Unless otherwise indicated herein, the approaches described in this section are not prior art to the claims in this application and are not admitted to be prior art by inclusion in this section.

The capabilities of modern digital signal processing now make possible a wide range of applications that can modify or extract information from digital video signals, either in real-time or off-line. For instance, viewing enhancements can be performed in real-time on a broadcast video, such as image adjustment and color correction. Similarly, visual effects that are superimposed on and move in conjunction with video content can be created and displayed in real-time for sporting events and the like.

Modern digital signal processing also enables information to be extracted from a digital video signal. For example, when a person is captured in a digital video, his or her biological or physiological information, such as respiration rate, heart rate, and even certain circulatory issues, may be detected through quantitative analysis of the video. Although this capability can be helpful in telemedicine and other remote-diagnosis medicine, it also raises privacy concerns. Specifically, a person's biological, physiological, or health information, which is generally deemed private information, may now be determined via digital video without the knowledge or consent of the person being targeted. Thus, while advancements in digital video technology can enhance web-based medicine, there are also drawbacks.

### SUMMARY

In accordance with at least some embodiments of the present disclosure, a computer-implemented method of processing a video data signal comprises acquiring a first sequence of video frames from the video data signal, extracting a time-varying signal from the first sequence of video frames, the time-varying signal being selected from a frequency band in which a physiological characteristic of a subject of a video that is generated by the video data signal can be detected, inverting the time-varying signal, and adding the inverted time-varying signal to the first sequence of video frames to generate a second sequence of video frames in which the presence of the time-varying signal is reduced.

In accordance with at least some embodiments of the present disclosure, a computer-implemented method of processing a video data signal comprises acquiring a first sequence of video frames from the video data signal, generating a signal having a signal profile in a frequency band selected to include a physiological characteristic of a subject of a video that is generated by the video data signal, and generating a second sequence of video frames by adding the generated signal to the first sequence of video frames.

In accordance with at least some embodiments of the present disclosure, a computing device comprises a memory and a processor coupled to the memory. The processor may be configured to acquire a first sequence of video frames from a video data signal, extract a time-varying signal from the first sequence of video frames, the time-varying signal being selected from a frequency band in which a physiological characteristic of a subject of a video that is generated by the video data signal can be detected, invert the time-varying signal, and add the inverted time-varying signal to the first sequence of video frames to generate a second sequence of video frames in which the presence of the time-varying signal is reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates a block diagram of an example embodiment of a digital video processing system;

FIG. 2 sets forth a flowchart summarizing an example method for modifying a digital video signal to mask biological information;

FIG. 3 illustrates a time-varying signal extracted from video frames for a specific pixel in the video frames;

FIG. 4 illustrates a time-varying signal for a specific pixel in video frames after being processed with a bandpass filter;

FIG. 5 sets forth a flowchart summarizing an example method for modifying a digital video signal with a noise signal to mask biological information; and

FIG. 6 is a block diagram of an illustrative embodiment of a computer program product for implementing a method for processing a video data signal, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the disclosure, as generally described herein, and illustrated in the Figures, can be arranged, substituted, combined, and designed in a wide variety of different configurations, all of which are explicitly contemplated and make part of this disclosure.

Throughout the present disclosure, the terms “biological information” and “physiological information” are used interchangeably. Some examples of such information may include, without limitation, a person's heart rate, respiration rate, certain circulatory information, and others.

According to some embodiments of the present disclosure, systems and methods of masking physiological information that may be contained in a digital video signal are disclosed. Specifically, a time-varying signal that is present in the digit video signal, and which can be used to determine heart rate and/or other circulatory information, can be either supplanted with a replacement time-varying signal, negated, or obfuscated with a noise signal. Negation of the time-varying signal present in a digital video signal can be accomplished by extracting said time-varying signal from the digital video signal as a discrete-time series, inverting the time-varying signal by multiplying the extracted discrete-time series by −1, and adding the inverted time-varying signal to the original digital video signal. Obfuscation of the time-varying signal can be accomplished by introducing a suitable noise signal to the original digital video signal. Supplanting the time-varying signal with a replacement signal generally includes negating the time-varying signal and introducing a desired replacement signal to the digital video signal.

FIG. 1 illustrates a block diagram of an example digital video processing system 100, arranged in accordance with at least some embodiments of the present disclosure. Digital video processing system 100 is configured to generate a digital video output signal 109, in which physiological information of a subject in the video has been masked or removed. In the embodiment illustrated in FIG. 1, digital video processing system 100 is configured for use in conjunction with a digital camera 101, and receives a digital video input signal 103 from digital camera 101. However, any other technically feasible digital video source may be used. For example, in other embodiments, digital video input signal 103 may include a recorded digital video, and digital video processing system 100 may be configured to receive digital video input signal 103 from a suitable device storing digital video input signal 103. In either case, digital video input signal 103 may include physiological information of a subject in a video that is generated by digital video input signal 103. Digital video processing system 100 may generate digital video output signal 109 based on digital video input signal 103, where physiological information of the subject in digital video output signal 109 has been masked or removed.

Digital camera 101 is configured to capture images of a subject 102 as a digital video and to transmit the digital video to digital video processing system 100 as digital video signal 103. Digital camera 101 may be any technically feasible configuration of a digital camera suitable for generating digital video signal 103, including a conventional digital video camera, an analog video camera coupled to an analog-to-digital converter (ADC), a digital camera incorporated into an electronic device (such as a smart phone, tablet, or laptop computer), and the like.

Digital video processing system 100 includes one or more input/output (I/O) ports 110, a digital signal processor (DSP) 120, and a memory 130. I/O ports 110 are configured to facilitate communications with digital camera 101, other external devices, and/or network communication links. DSP 120 includes any suitable microprocessor for running digital signal processing algorithms for generating digital video output signal 109. For example, DSP 120 may include a general-purpose microprocessor, an application-specific integrated circuit (ASIC), a field-programmable gate array (FPGA), and the like. Memory 130 includes a video buffer 131 for storing video frames 103F constructed from digital video input signal 103 and video frames 109F used to generate digital video output signal 109. Memory 130 is also configured to store application data 132 that may be used by DSP 120 during operation, such as software code for performing the video processing algorithms described herein.

FIG. 2 sets forth a flowchart summarizing an example method 200 for modifying a digital video signal to mask physiological information, arranged in accordance with at least some embodiments of the present disclosure. Method 200 may include one or more operations, functions, or actions as illustrated by one or more of blocks 201-210. Although the blocks are illustrated in a sequential order, these blocks may be performed in parallel, and/or in a different order than those described herein. Also, the various blocks may be combined into fewer blocks, divided into additional blocks, and/or eliminated based upon the desired implementation. Although method 200 is described in conjunction with digital video processing system 100 of FIG. 1, persons skilled in the art will understand that any digital video processing system configured to perform method 200 is within the scope of the present disclosure.

In block 201, digital video processing system 100 receives digital video input signal 103 from digital camera 101, the latter generating digital video input signal 103 based on video frames that capture subject 102. Subject 102 may be a single person or a group of multiple persons. In block 201, digital video processing system 100 also constructs video frames 103F from digital video input signal 103 and buffers video frames 103F in video buffer 131. In some embodiments, frames 103F include a complete video, and in other embodiments, frames 103F make up a portion of a video.

In optional block 202, digital video processing system 100 performs one or more processes on video frames 103F in order to reduce the computational complexity of subsequent processes described below. Consequently, in some embodiments, block 202 is performed when computational resources available to DSP 120 are limited, and in other embodiments block 202 is not performed as part of method 200.

In some embodiments, in block 202 DSP 120 downsamples video frames 103F one or more times to form downsampled versions of each video frame 103F. The downsampled versions of video frames 103F have significantly fewer pixels than the corresponding original video frames 103F. Consequently, when the downsampled versions of video frames 103F are used in method 200, fewer total pixels need to be processed in blocks 203-205 of method 200. For example, given an original video frame that is 640×480 pixels, downsampling once, i.e., removing half of the rows and columns, yields a downsampled frame having 320×240 pixels. Downsampling a second time yields a downsampled frame having 160×120 pixels.

In some embodiments, a low-pass filtering process is applied to each of frames 103F prior to downsampling. By performing low-pass filtering on frames 103F, image information between adjacent rows and columns of pixels in each frame 103F is linearly combined.

In block 203, multiple time-varying signals are extracted from video frames 103F, where each time-varying signal is associated with a spatial region common to each of the video frames 103F. In some embodiments, each spatial region in question is an individual pixel, either of the original-sized video frames 103F or of the downsampled versions of video frames 103F. In other embodiments, the spatial region in question includes multiple contiguous pixels. Generally, the number of time-varying signals extracted from video frames 103F is relatively large. For example, when a time-varying signal is extracted in block 203 for each pixel of a 640×480 pixel video frame, a total of 307,200 separate time-varying signals are extracted for video frames 103F. In another example, when a time-varying signal is extracted in block 203 for each pixel of a 160×120 pixel video frame, a total of 19,200 separate time-varying signals are extracted for video frames 103F. In some embodiments, each time-varying signal extracted from video frames 103F corresponds to changes in intensity of a particular spatial region of video frames 103F over the time period spanned by video frames 103F. An example of one such time-varying signal is illustrated in FIG. 3.

FIG. 3 illustrates a time-varying signal 300 extracted from video frames 103F in block 203 for a specific pixel in video frames 103F. As shown, time-varying signal 300 is depicted as a discrete-time series, i.e., a function of pixel intensity vs. frame (or time). Pixel intensity may be total pixel intensity, the intensity of a particular color component of the pixel of interest (for example, red intensity), or a weighted combination of the different color components for said pixel.

It is noted that in block 203, a time-varying signal similar to time-varying signal 300 is extracted from video frames 103F for each spatial region of interest in video frames 103F. In some embodiments, such spatial regions, when taken together, cover an entire video frame 103F. In other embodiments, such spatial regions correspond to a desired portion of each video frame 103F. For example, in such embodiments, a time-varying signal is extracted for the spatial regions of each video frame 103F that correspond to subject 102, while no time-varying signals are extracted for other spatial regions of video frames 103F, such as background regions, etc. Generally, additional face or object recognition algorithms are required for the effective implementation such embodiments. Any spatial regions associated with subject 102 may eligible for a time-varying signal to be extracted therefrom. Alternatively, specific portions of subject 102 may correspond to the spatial regions for which a time-varying signal is extracted, such as the face or other portion of the anatomy of subject 102.

In block 204 in FIG. 2, a bandpass filter is applied to the multiple time-varying signals that are extracted in block 203. As noted previously, digital signal processing can be used to generate physiological information that may be contained in the frames of a digital video of a person, such as subject 102. For example, algorithms are known in the art for determining heart rate and/or other circulatory information of a person, such as the presence of asymmetrical blood flow, from a digital video of the person. Consequently, so that such physiological or health information can be subsequently masked, the bandpass filter applied in block 204 to the time-varying signals is selected to exclude all but a specific frequency band approximately equal to a heart rate of subject 102. For example, since the human heart rate is rarely less than 0.5 Hz or higher than 4 Hz, in some embodiments the bandpass filter applied in block 204 removes the portion of the time-varying signals extracted in block 203 greater than about 4 Hz and the portion less than about 0.5 Hz. In other embodiments, the specific passband of the bandpass filter is selected for a narrower frequency band based on specific information associated with subject 102. For example, there are known correlations between heart rate the heart rate of a person and the age, gender, and athletic ability of the person. Thus, in some embodiments, based on applicable health and other physiological information of subject 102, the passband of the bandpass filter applied in block 203 may be selected to be narrower than 0.5 Hz to 4 Hz. An example of one such time-varying signal is illustrated in FIG. 4.

FIG. 4 illustrates a time-varying signal 400 for a specific pixel in video frames 103F after being processed with a bandpass filter in block 204. As shown, the frequency band proximate the range of human heart rates, i.e., 0.5 Hz to 4 Hz, remains, while the majority of frequency bands present in time-varying signal 300 in FIG. 3 have been removed. As a result, time-varying signal 400 includes substantially all motion and/or color changes associated with the circulatory system of subject 102 that are manifested in video frames 103F. It is noted that in block 204, a time-varying signal similar to time-varying signal 400 is generated from video frames 103F for each spatial region of interest in video frames 103F.

In block 205, a cancellation signal is generated by DSP 120 for each spatial region of interest in video frames 103F. In some embodiments, the cancellation signal generated in block 205 is based on time-varying signal 400. For example, the amplitude of each time-varying signal 400 generated in block 204 is multiplied by −1.

In block 206, DSP 120 adds the cancellation signal generated in block 205 to video frames 103F to produce video frames 109F. In this way, most or all of the time-varying signals present in video frames 103F that occur in a desired frequency band are eliminated or greatly attenuated, and therefore are not present in video frames 109F. Specifically, the time-varying signals present in video frames 103F that are so affected are the time-varying signals disposed in the passband of the bandpass filter used in block 204, for example between about 0.5 Hz and about 5 Hz. In this way, substantially all motion and/or changes in color of subject 102 associated with the circulatory system of subject 102 can be effectively eliminated in the video frames 109F.

In embodiments in which downsampling of video frames 103F is performed in block 202 and time-varying signal 400 are based on down-sampled video frames, DSP 120 adds the cancellation signal to pixels corresponding to upsampled video frames. For example, when time-varying signals 400 are based on video frames that have been downsampled from a 640×480 pixel frame to a 320×240 pixel frame, a cancellation signal is generated in block 206 for one quarter the number of pixels that are present in the original video frames 103F. Thus, additional cancellation signals may be generated so that there is a corresponding cancellation signal for each pixel in a 640×480 pixel frame. The additional cancellation signals may be duplicates of cancellation signals associated with adjacent pixels or may be extrapolated from the values of surrounding cancellation signals.

In block 207, DSP 120 is configured to determine if any additional signal processing is to be performed. If a negation process is desired for video frames 103F, then method 200 proceeds to block 208. This is because a negation process has been completed in blocks 201-205. If a replacement signal is desired for supplanting the time-varying signals negated in blocks 201-205, then method 200 proceeds to block 209. If further obfuscation of the time-varying signals negated in blocks 201-205 is desired, then method 200 proceeds to block 210.

In block 208, DSP 120 generates digital video output signal 109 based on video frames 109F.

In block 209, DSP 120 adds a replacement time-varying signal to video frames 109F, then generates digital video output signal 109 based on the modified video frames 109F that contain the replacement time-varying signal. For example the replacement time-varying signal added to video frames 109F may be include alternate health or other physiological information for subject 102. Alternatively, the replacement time-varying signal may be configured to change in response to one or more inputs independent of video data signal 103. For example, temperature, weather, stock-market information, or any other information independent of video data signal 103 may be used as external input for altering the replacement time-varying signal added in block 209.

In block 210, DSP 120 adds a noise signal to video frames 109F, then generates digital video output signal 109 based on the modified video frames 109F that contain the noise signal. For example, the noise signal may include random noise in the passband of the bandpass filter applied in block 204. In this way, health or other physiological information for subject 102 that may be detectable in video frames 109F can be further masked. The addition of a noise signal to video frames 109F can be particularly beneficial for instances in which the cancellation signal generated in block 205 fails to completely negate a time-varying signal associated with the circulatory system of subject 102. Thus, physiological information related to the circulatory system of subject 102 can be more likely rendered undetectable.

FIG. 5 sets forth a flowchart summarizing an example method 500 for modifying a digital video signal with a noise signal to mask physiological information, arranged in accordance with at least some embodiments of the present disclosure. Method 500 may include one or more operations, functions, or actions as illustrated by one or more of blocks 501-507. Although the blocks are illustrated in a sequential order, these blocks may be performed in parallel, and/or in a different order than those described herein. Also, the various blocks may be combined into fewer blocks, divided into additional blocks, and/or eliminated based upon the desired implementation. Although method 500 is described in conjunction with digital video processing system 100 of FIG. 1, persons skilled in the art will understand that any digital video processing system configured to perform method 500 is within the scope of the present disclosure.

In block 501, digital video processing system 100 receives digital video input signal 103 from digital camera 101, which generates digital video input signal 103 based on video frames that capture subject 102. Subject 102 may be a single person or a group of multiple persons. In block 501, digital video processing system 100 also constructs video frames 103F from digital video input signal 103 and buffers video frames 103F in video buffer 131. In some embodiments, frames 103F include a complete video, and in other embodiments, frames 103F make up a portion of a video.

Optional blocks 502-506 are substantially similar to blocks 202-206, respectively, in method 200. For example, the low-pass filtering and/or downsampling of block 502 may be performed. In another example, the generation and application of a cancellation signal of blocks 503-506 may be performed to reduce or attenuate physiological information related to the circulatory system of subject 102.

In block 507, DSP 120 adds a noise signal to video frames 109F, then generates digital video output signal 109 based on the modified video frames 109F that contain the noise signal. For example, the noise signal may include random noise in the pass band of the bandpass filter applied in block 204. In this way, health or other physiological information for subject 102 that may be detectable in video frames 109F can be further masked. As noted above, the addition of a cancellation signal in blocks 503-506 is optional; in some embodiments, DSP 120 simply adds a noise signal to video frames 109F and does not extract a time-varying signal or otherwise generate a cancellation signal.

FIG. 6 is a block diagram of an illustrative embodiment of a computer program product 600 for implementing a method for processing a video data signal. Computer program product 600 may include a signal bearing medium 604. Signal bearing medium 604 may include one or more sets of executable instructions 602 that, when executed by, for example, a processor of a computing device, may provide at least the functionality described above with respect to FIGS. 1-5.

In some implementations, signal bearing medium 604 may encompass a non-transitory computer readable medium 608, such as, but not limited to, a hard disk drive, a Compact Disc (CD), a Digital Video Disk (DVD), a digital tape, memory, etc. In some implementations, signal bearing medium 604 may encompass a recordable medium 610, such as, but not limited to, memory, read/write (R/W) CDs, R/W DVDs, etc. In some implementations, signal bearing medium 604 may encompass a communications medium 606, such as, but not limited to, a digital and/or an analog communication medium (e.g., a fiber optic cable, a waveguide, a wired communications link, a wireless communication link, etc.). Computer program product 600 may be recorded on non-transitory computer readable medium 608 or another similar recordable medium 610.

In sum, embodiments of the present disclosure enable modifying a digital video signal to mask physiological information of a subject person in a video generated by the digital video signal. A time-varying signal that is present in the digit video signal, and which can be used to determine heart rate and/or other circulatory information, can be either supplanted with a replacement time-varying signal, negated, or obfuscated with a noise signal.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A computer-implemented method of processing a video data signal, the method comprising:
acquiring a first sequence of video frames from the video data signal;
extracting a time-varying signal from the first sequence of video frames, the time-varying signal being selected from a frequency band in which a physiological characteristic of a subject of a video that is generated by the video data signal can be detected;
inverting the time-varying signal; and
adding the inverted time-varying signal to the first sequence of video frames to generate a second sequence of video frames in which the presence of the time-varying signal is reduced.

2. The method of claim 1, further comprising adding a noise signal to the first sequence of video frames.

3. The method of claim 1, further comprising adding a replacement time-varying signal to the first sequence of video frames.

4. The method of claim 3, wherein the replacement time-varying signal changes in response to an input independent of the video data signal.

5. The method of claim 3, wherein the replacement time-varying signal is selected based on an age of the subject of the video.

6. The method of claim 1, wherein the time-varying signal is associated with a spatial region common to each of the video frames in the first sequence of video frames.

7. The method of claim 6, wherein the spatial region comprises a single pixel.

8. The method of claim 6, wherein the spatial region comprises multiple contiguous pixels.

9. The method of claim 1, wherein extracting a time-varying signal comprises downsampling frames in the first sequence of video frames.

10. The method of claim 9, wherein extracting a time-varying signal further comprises lowpass filtering the time-varying signal prior to downsampling frames in the first sequence of video frames.

11. The method of claim 1, wherein extracting a time-varying signal comprises extracting a plurality of time-varying signals, each of the plurality of time-varying signals being based on a different spatial region of the video frames in the first sequence of video frames.

12. The method of claim 1, wherein the frequency band is between about 0.5 Hz and about 4 Hz.

13. The method of claim 1, wherein the time-varying signal can be used to determine health information associated with the subject of the video.

14. A computer-implemented method of processing a video data signal, the method comprising:
acquiring a first sequence of video frames from the video data signal;
generating a signal having a signal profile in a frequency band selected to include a physiological characteristic of a subject of a video that is generated by the video data signal; and
generating a second sequence of video frames by adding the generated signal to the first sequence of video frames.

15. The method of claim 14, further comprising:
extracting a time-varying signal from the first sequence of video frames, the time-varying signal being selected from the frequency band;
inverting the time-varying signal; and
adding the inverted time-varying signal to the first sequence of video frames to generate a second sequence of video frames in which the presence of the time-varying signal is reduced.

16. The method of claim 15, wherein the generated signal comprises a noise signal selected to obfuscate a time-varying signal from the first sequence of video frames disposed in the frequency band.

17. The method of claim 15, wherein the generated signal comprises a replacement time-varying signal that has a signal profile in the frequency band.

18. The method of claim 15, wherein the time-varying signal can be used to determine health information associated with the subject of the video.

19. A computing device comprising:
a memory; and
a processor coupled to the memory, the processor being configured to:
acquire a first sequence of video frames from a video data signal;
extract a time-varying signal from the first sequence of video frames, the time-varying signal being selected from a frequency band in which a physiological characteristic of a subject of a video that is generated by the video data signal can be detected;
invert the time-varying signal; and
add the inverted time-varying signal to the first sequence of video frames to generate a second sequence of video frames in which the presence of the time-varying signal is reduced.

20. The computing device of claim 19, wherein the time-varying signal can be used to determine health information associated with the subject of the video.
